(19) United States
(12) Patent Application Publication
(10) Pub. No.: US 2026/0262581 A1
(43) Pub. Date: Sep. 10, 2026

(54) TWISTED STREET TREES WITH WIND-RESISTANCE AND THEIR CULTIVATION METHOD

(71) Applicant: Eunbit HWANG, Seoul (KR)

(72) Inventor: Eunbit HWANG, Seoul (KR)

(21) Appl. No.: 19/362,448

(22) Filed: Oct. 19, 2025

(30) Foreign Application Priority Data
Mar. 7, 2025 (SG) 10202500588Q

(51) Int. Cl. A01G 17/00

(52) U.S. Cl. CPC A01G 17/005

(57) ABSTRACT

Provided are twisted street trees with a wind-resistance or a strong wind resistance and a cultivation method thereof. To this end, a cultivation method of a twisted street tree with a wind-resistance includes a step of germinating sprouts by sowing seeds in a first pot, a step of growing a seedling to have a height of stem of 20 to 30 cm, a step of planting a first seedling and a second seedling together in a second pot larger than the first pot, a step of pruning parts of stems of the first seedling and the second seedling, a step of spirally twisting the pruned areas of the first seedling and the second seedling to be fixed, and a step of growing the first seedling and the second seedling which are twisted with each other as a twisted tree with a height of 5 to 7 m.

### BACKGROUND

### Field

The present disclosure relates to twisted street trees with a wind-resistance or a strong wind resistance and a cultivation method thereof.

### Description of the Related Art

In general, street trees are planted in a row along the roadside to help beautify the city and improve the environment. However, these street trees are often broken when strong winds or typhoons hit (this is called a falling-down phenomenon). This falling-down phenomenon not only causes the disposal of street trees, but also causes a secondary damage to surrounding vehicles, facilities, power lines, and pedestrians when the trees fall. The larger the street tree, the more frequent the falling-down phenomenon.

In order to overcome this falling-down phenomenon, in the related art, supports were installed for the street trees or trees with a wind-resistance (the property of not breaking easily) were replaced. However, the installation of supports was only a temporary measure, and the selection of trees that had a wind-resistance and were suitable for use as street trees was extremely limited.

### Related Art Document

### Patent Document

Korean Registered Patent No. 10-1261808 (Apparatus for protection of street tree)

### SUMMARY

Accordingly, the present disclosure is made to solve the problems as described above and an object to be achieved by the present disclosure is to provide twisted street trees with wind-resistance which do not fall down by the wind and a cultivation method thereof.

Technical objects to be achieved in the present disclosure are not limited to the aforementioned technical objects, and another not-mentioned technical object will be clearly understood by those skilled in the art from the description below.

In order to achieve the above-described technical objects, a cultivation method of a twisted street tree with a wind-resistance includes a step S100 of germinating sprouts by sowing seeds in a first pot; a step S120 of growing a seedling to have a height of stem of 20 to 30 cm; a step S140 of planting a first seedling 32 and a second seedling 34 together in a second pot larger than the first pot; a step S160 of pruning parts of stems of the first seedling 32 and the second seedling 34; a step S180 of spirally twisting the pruned areas 36 of the first seedling 32 and the second seedling 34 to be fixed; and a step S200 of growing the first seedling 32 and the second seedling 34 which are twisted with each other as a twisted tree with a height of 5 to 7 m.

Optionally, the seed is a seed of a madagascar almond tree, a bucida molinetii, a cherry tree, a ginkgo tree, a london plane tree, a dawn redwood, a chinese fringe tree, a japanese zelkova tree, a maple tree, a japanese pagoda tree, a tulip tree, or a sycamore tree.

a seed of a Madagascar almond tree or a seed of Bucida molinetii.

Optionally, the first pot is a vinyl pot 10 and the second pot is a plastic pot 30.

Optionally, in the germinating step S100, a plurality of seeds is sown in the first pot to germinate a first sprout 22 and a second sprout 24.

Optionally, in the pruning step S160, stems of the first seedling 32 and the second seedling 34 are pruned to a height of 20 cm from the soil.

Optionally, the fixing step S180 further includes a step of fastening an upper portion of the pruned areas 36 with an upper tie 80 and fastening a lower portion of the pruned areas 36 with a lower tie 82.

Optionally, the cultivation method further includes a step S220 of exposing a root of the twisted tree (bare root); a step S240 of supplying water after wrapping a root of the twisted tree with palm tree powder; a step S260 of loading the twisted tree in a container to be moved; and a step S300 of planting the twisted tree as a twisted street tree.

The object of the present disclosure as described is also achieved by a twisted street tree with a wind-resistance which is grown by the above-described cultivation method.

According to the exemplary embodiment, twisted street trees will not be broken or be uprooted even in strong winds or typhoons. Therefore, the street trees can be protected and can be significantly grown for decades. This not only makes the city beautiful but also changes the city to be eco-friendly from various types of pollution.

Further, the falling-down of the street tree is prevented to prevent the secondary damage to surrounding vehicles, facilities, power lines, and pedestrians in advance.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The following drawings attached to the present specification illustrate the exemplary embodiment of the present disclosure and are provided for better understanding of the technical spirit of the present disclosure together with the detailed description of the invention to be described. Therefore, the present disclosure should not be construed as being limited only to the matters described in the drawings. The above and other aspects, features and other advantages of the present disclosure will be more clearly understood from the following detailed description taken in conjunction with the accompanying drawings, in which:

FIG. 1 is an explanatory diagram illustrating a state in which seeds are sown in a vinyl pot 10 to germinate sprouts in a cultivation method of twisted street trees with a wind-resistance according to the present disclosure;

FIG. 2 is another modified exemplary embodiment of FIG. 1;

FIG. 3 is an explanatory diagram illustrating a state in which first and second seedlings 32 and 34 are planted in a plastic pot 30 together in a cultivation method according to the present disclosure;

FIG. 4 is an explanatory diagram illustrating a state in which the first and second seedlings 32 and 34 are pruned in a cultivation method according to the present disclosure;

FIG. 5 is an explanatory diagram illustrating a state in which the first and second seedlings 32 and 34 are spirally twisted in a cultivation method according to the present disclosure;

FIG. 6 is a perspective view of a twisted tree according to the present disclosure which is planted on a sidewalk 55 to be utilized as a twisted street tree 70; and

FIG. 7 is a flowchart illustrating a cultivation method of a twisted street tree with a wind-resistance according to an exemplary embodiment of the present disclosure.

### DETAILED DESCRIPTION OF THE EMBODIMENT

In the following detailed description, only certain exemplary embodiments of the present disclosure have been shown and described, simply by way of illustration. Description of the present disclosure is just an exemplary embodiment for structural and functional description so that the scope of the present disclosure is not interpreted to be limited by the exemplary embodiment described in the specification. That is, the exemplary embodiment may be modified in various forms so that it is understood that the scope of the present disclosure has equivalents which are capable of implementing the technical spirit. Further, it does not mean that the specific exemplary embodiment includes the object or effect proposed in the present disclosure or includes only the effect so that it is not understood that the scope of the present disclosure is limited thereby.

In the meantime, meanings of terms described in the present disclosure can be understood as follows.

The terms “first” or “second” are used to distinguish one component from the other component so that the scope should not be limited by these terms. For example, a first component may be referred to as a second component, and similarly, a second component may be referred to as a first component. It should be understood that, when it is described that an element is “connected” to another element, the element may be directly connected to the other element or connected to the other element through a third element. In contrast, it should be understood that, when it is described that an element is directly connected to another element, no element is present between the element and the other element. In the meantime, other expressions which describe the relationship between components, that is, “between” and “directly between”, or “adjacent to” and “directly adjacent to” need to be interpreted by the same manner.

Unless the context apparently indicates otherwise, it should be understood that singular expressions include plural expressions and terms “include” or "have” indicate that a feature, a number, a step, an operation, a component, a part or the combination thereof described in the specification is present, but do not exclude a possibility of presence or addition of one or more other features, numbers, steps, operations, components, parts or combinations thereof, in advance.

Unless they are contrarily defined, all terms used herein including technological or scientific terms have the same meaning as those generally understood by a person with ordinary skill in the art. Terms which are defined in a generally used dictionary should be interpreted to have the same meaning as the meaning in the context of the related art but are not interpreted as an ideally or excessively formal meaning if it is not clearly defined in the present disclosure.

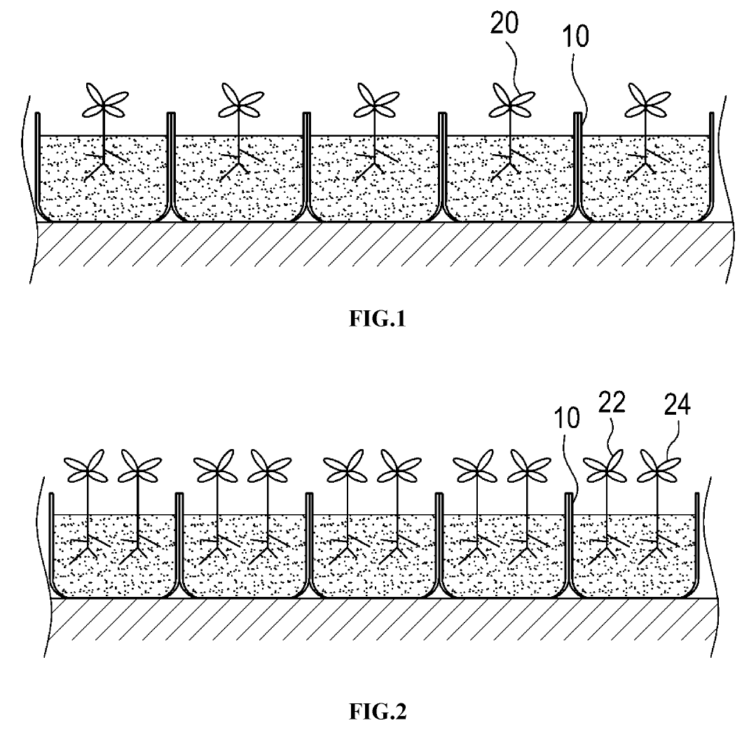

Hereinafter, preferred exemplary embodiments will be described in detail with reference to the accompanying drawings. FIG. 7 is a flowchart illustrating a cultivation method of a twisted street tree with a wind-resistance according to an exemplary embodiment of the present disclosure. As illustrated in FIG. 7, first, seeds are sown in a first pot to germinate sprouts (S100). FIG. 1 is an explanatory diagram illustrating a state in which seeds are sown in a vinyl pot 10 to germinate sprouts 20 in a cultivation method of twisted street trees with a wind-resistance according to the present disclosure. As illustrated in FIG. 1, the first pot is a vinyl pot 10 and seeds may be seeds of Madagascar almond tree or seeds of Bucida molinetii. However, the seeds are not limited to these varieties, and can be applied to any plant with soft stems in the seedling stage. A diameter of the vinyl pot 10 is 8 to 10 cm and a height is 8 to 10 cm.

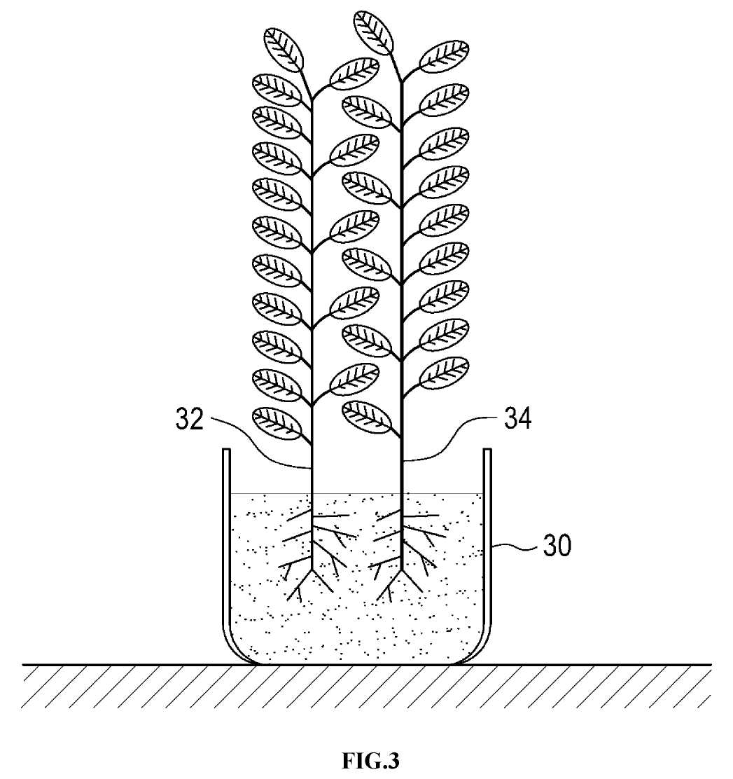

FIG. 2 is another modified exemplary embodiment of FIG. 1. As illustrated in FIG. 2, in the germinating step S100, a plurality (two or three) of seeds is sown in the vinyl pot 10 to germinate a first sprout 22 and a second sprout 24. The first sprout 22 and the second sprout 24 are moved as it is to be planted in a plastic pot 30. Optionally, a third sprout may also be plated together.

Next, the sprouts are grown as seedlings to have a height of a stem of 20 to 30 cm (S120).

Next, a first seedling 32 and a second seedling 34 are planted together in a plastic pot 30 which has a diameter and a height larger than those of the vinyl pot 10. FIG. 3 is an explanatory diagram illustrating a state in which first and second seedlings 32 and 34 are planted in a plastic pot 30 together in a cultivation method according to the present disclosure. As illustrated in FIG. 3, a diameter of the plastic pot 30 is 30 to 40 cm and a height is 30 to 40 cm.

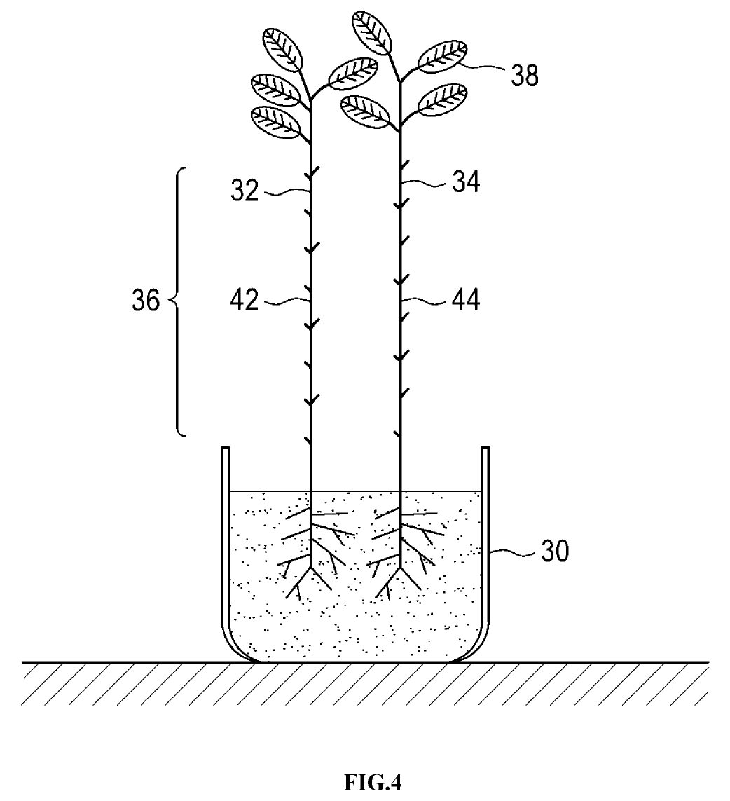

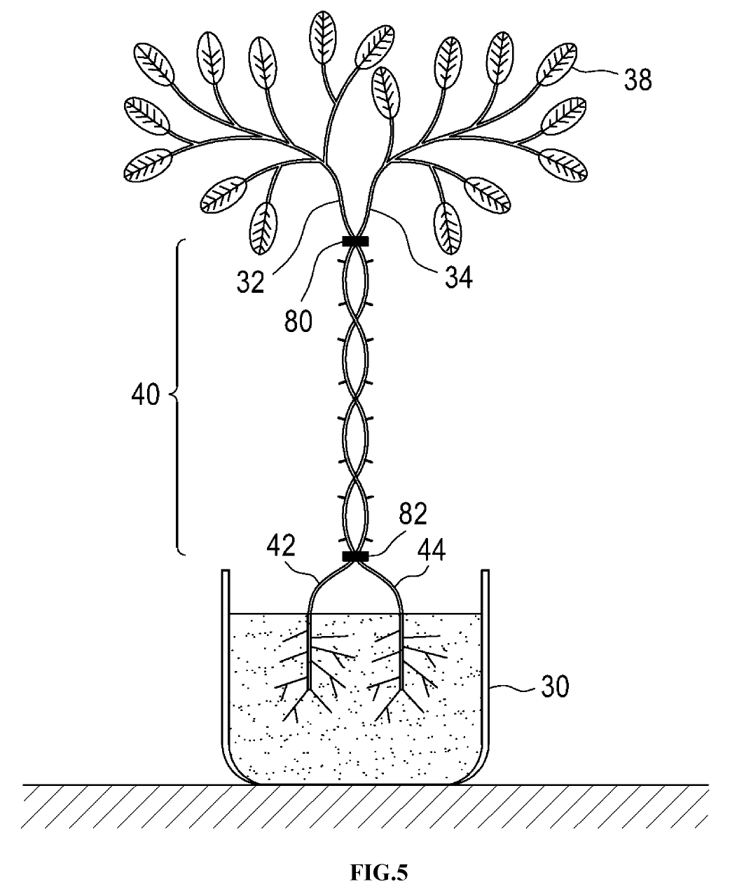

Next, parts of stems of the first seedling 32 and the second seedling 34 are pruned (S160). FIG. 4 is an explanatory diagram illustrating a state in which the first and second seedlings 32 and 34 are pruned in a cultivation method according to the present disclosure. As illustrated in FIG. 4, pruned areas 36 may be 20 cm high from the soil, of the stems of the first seedling 32 and the second seedling 34. Pruning makes it easier to twist the stems. Optionally, the pruned areas 36 may be 70 to 80% of lengths of the stems of the first seedling 32 and the second seedling 34. Below 70%, the twisted area is reduced, which greatly reduces the twist effect and above 80%, the number of leaves is too small, which greatly slows down the growth.

Next, the pruned areas 36 of the first seedling 32 and the second seedling 34 are spirally twisted to be fixed (S180). FIG. 5 is an explanatory diagram illustrating a state in which the first and second seedlings 32 and 34 are spirally twisted in a cultivation method according to the present disclosure. As illustrated in FIG. 5, the pruned areas 36 are spirally twisted two to four times to form a twisted shape while leaving the roots of the first and second seedlings 32 and 34 intact. Since they are still in the seedling state, the stem is not thick, but is soft so that the spiral shape may be easily implemented. At this time, in order to maintain the twisted shape, an upper portion of the pruned areas 36 is fastened with an upper tie 80 and a lower portion of the pruned areas 36 is fastened with a lower tie 82. Examples of the upper tie 80 and the lower tie 82 may include cable ties, wires, strings, or the like.

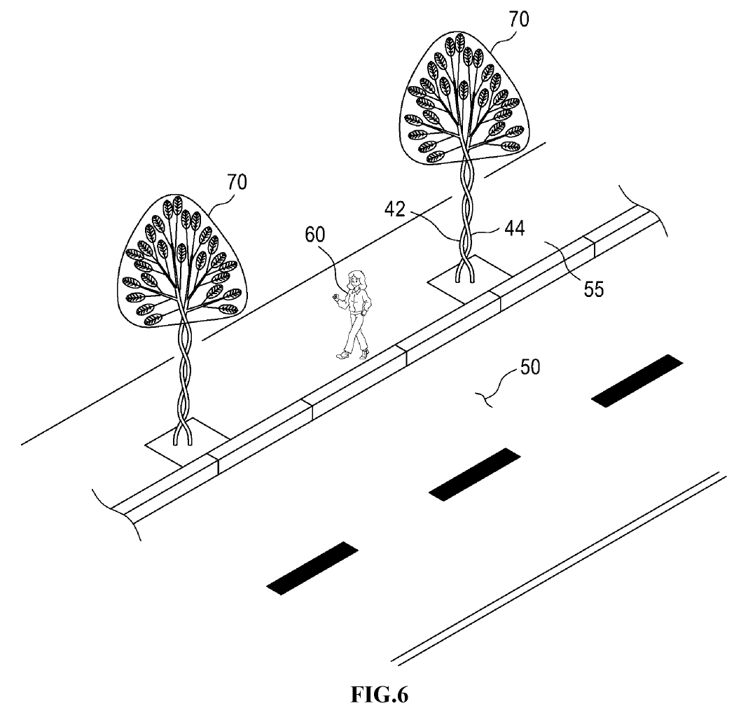

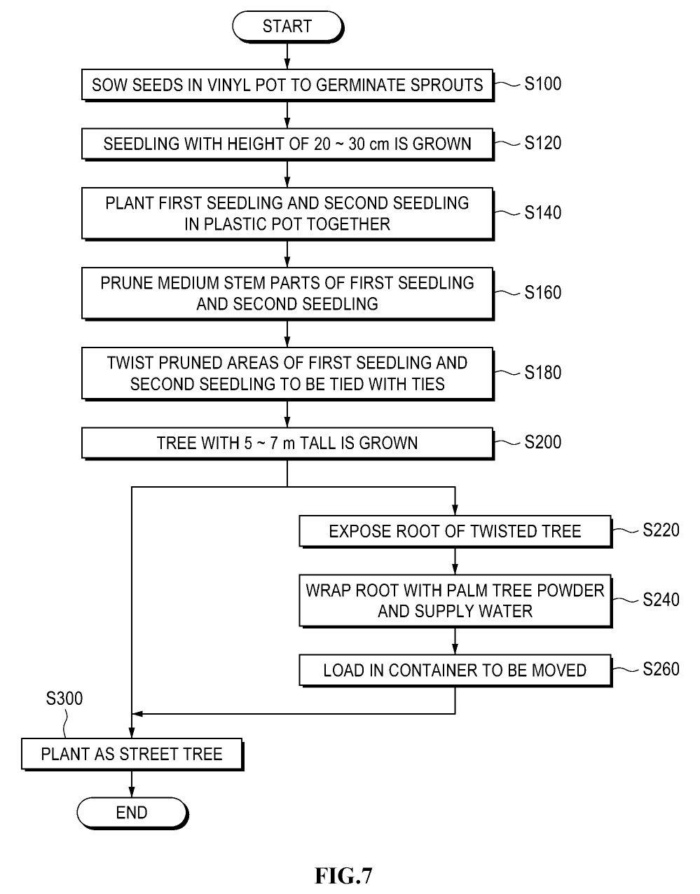

Next, the first seedling 32 and the second seedling 34 which are twisted with each other are grown as a twisted tree with a height of 5 to 7 m. The twisted tree with a height of 5 to 7 m may be planted as a street tree as it is (S300). FIG. 6 is a perspective view of a twisted tree according to the present disclosure which is planted on a sidewalk 55 to be utilized as a twisted street tree 70.

Optionally, when the twisted tree with a height of 5 to 7 m is distributed over a long distance (for example, overseas export), the following steps may be additionally performed. First, a root of the twisted tree (bare root) is exposed (S220). A bare-root task refers to a task of removing soil from the root when the tree is moved.

Next, the exposed root of the twisted tree is wrapped with palm tree powders and then watered (S240).

Next, the twisted tree is loaded in a container to be moved (S260). The twisted tree with a height of 5 to 7 m is suitable for stacking in a container.

Next, the twisted tree is planted as a twisted street tree (S300).

As described above, the planted twisted street tree grows up to 30 m tall, with two twisted trees growing closely together. Stem parts serve as supports for each other with different roots. Specifically, the spirally twisted stem part prevents the concentration of the loads due to strong wind and is advantageous to disperse the loads. Accordingly, the twisted street tree has increased bending stiffness due to wind, resulting in high wind-resistance.

As described above, the detailed description of the preferred exemplary embodiments of the disclosed present disclosure is provided such that those skilled in the art implement and carry out the present disclosure. While the disclosure has been described with reference to the preferred exemplary embodiments, it will be understood by those skilled in the art that various changes and modifications of the present disclosure may be made without departing from the spirit and scope of the disclosure. For example, those skilled in the art may use configurations disclosed in the above-described exemplary embodiments by combining them with each other. Therefore, the present disclosure is not intended to be limited to the above-described exemplary embodiments but to assign the widest scope consistent with disclosed principles and novel features.

The present disclosure may be implemented in another specific form within the scope without departing from the spirit and essential feature of the present disclosure. Therefore, the detailed description should not restrictively be analyzed in all aspects and should be exemplarily considered. The scope of the present disclosure should be determined by rational interpretation of the appended claims and all changes are included in the scope of the present disclosure within the equivalent scope of the present disclosure. The present disclosure is not intended to be limited to the above-described exemplary embodiments but to assign the widest scope consistent with disclosed principles and novel features. Further, claims having no clear quoting relation in the claims are combined to configure the exemplary embodiment or may be included as new claims by correction after application.

1. A cultivation method of a twisted street tree with a wind-resistance, comprising:
a step S100 of germinating sprouts by sowing seeds in a first pot;
a step S120 of growing a seedling to have a height of a stem of 20 to 30 cm;
a step S140 of planting a first seedling (32) and a second seedling (34) together in a second pot larger than the first pot;
a step S160 of pruning parts of the stems of the first seedling (32) and the second seedling (34);
a step S180 of spirally twisting the pruned areas (36) of the first seedling (32) and the second seedling (34) to be fixed; and
a step S200 of growing the first seedling (32) and the second seedling (34) which are twisted with each other as a twisted tree with a height of 5 to 7 m.

2. The cultivation method of a twisted street tree with a wind-resistance according to claim 1, wherein the seed is a seed of a madagascar almond tree, a bucida molinetii, a cherry tree, a ginkgo tree, a london plane tree, a dawn redwood, a chinese fringe tree, a japanese zelkova tree, a maple tree, a japanese pagoda tree, a tulip tree, or a sycamore tree.

3. The cultivation method of a twisted street tree with a wind-resistance according to claim 1, wherein the first pot is a vinyl pot (10) and the second pot is a plastic pot (30).

4. The cultivation method of a twisted street tree with a wind-resistance according to claim 1, wherein in the germinating step S100, a plurality of seeds is sown in the first pot to germinate a first sprout (22) and a second sprout (24).

5. The cultivation method of a twisted street tree with a wind-resistance according to claim 1, wherein in the pruning step S160, the stems of the first seedling (32) and the second seedling (34) are pruned to a height of 20 cm from the soil.

6. The cultivation method of a twisted street tree with a wind-resistance according to claim 1, wherein the fixing step S180 further includes a step of fastening an upper portion of the pruned areas (36) with an upper tie (80) and fastening a lower portion of the pruned areas (36) with a lower tie (82).

7. The cultivation method of a twisted street tree with a wind-resistance according to claim 1, further comprising:
a step S220 of exposing a root of the twisted tree (bare root);
a step S240 of supplying water after wrapping a root of the twisted tree with palm tree powder;
a step S260 of loading the twisted tree in a container to be moved; and
a step S300 of planting the twisted tree as the twisted street tree.

8. A twisted street tree with a wind-resistance grown by the cultivation method according to claim 1.
